(19) United States
(12) Patent Application Publication
(10) Pub. No.: US 2007/0118981 A1
(43) Pub. Date: May 31, 2007

(54) Toilet apparatus with a vacuum breaker diverter

(75) Inventor: Stephan R. Kovey, Indianapolis, IN (US)

Correspondence Address: PEARNE & GORDON LLP, 1801 EAST 9TH STREET, SUITE 1200, CLEVELAND, OH, 44114-3108, US

(73) Assignee: Dometic Sanitation Corporation, Big Prairie, OH (US)

(21) Appl. No.: 11/438,802

(22) Filed: May 23, 2006

Related U.S. Application Data
(60) Provisional application No. 60/740,072, filed on Nov. 28, 2005.

(51) Int. Cl. E03D 3/00; A61G 9/00

(52) U.S. Cl. 4/300.2

(57) ABSTRACT

A toilet apparatus adapted to be placed in fluid communication with a fluid source comprises a toilet including a bowl, a fluid dispenser, and a flush valve. A spraying apparatus is further provided having a spray valve biased to a closed position, and can be adapted to dispense a fluid upon opening of the spray valve. In one example, a vacuum breaker diverter can be adapted to direct greater than 41% of the fluid to the spraying apparatus, while the flush valve is open. In addition or alternatively, the vacuum breaker diverter can include a diverter chamber and a diverter device movable within the diverter chamber between a first position and a second position.

### RELATED APPLICATIONS

This application claims the benefit of U.S. Provisional Application No. 60/740,072, filed on Nov. 28, 2005, the entire disclosure of which is hereby incorporated herein by reference.

### FIELD OF THE INVENTION

The present invention relates generally to a fluid diverter device, and more particularly, to a toilet apparatus including a vacuum breaker diverter.

### BACKGROUND OF THE INVENTION

Recreation vehicles are known to include toilets with a hand spray nozzle for cleaning the toilet bowl. FIG. 1 illustrates a partial exploded view of portions of a conventional toilet 10 including a conventional hand spray nozzle 28. The conventional toilet 10 includes a main body portion 12 with a toilet bowl 14 and a flush rim 16 for dispensing water into the toilet bowl 14. A foot pedal 20 can be pressed to open a flush valve 18 and thereby dispense water through the flush rim 16 and into the toilet bowl 14. The conventional toilet 10 also includes a lid 13 and seat 15 shown exploded from the main body portion 12.

FIGS. 1, 2A and 2B illustrate a conventional vacuum breaker diverter 24 of the conventional toilet 10, in somewhat simplified, schematic form. The conventional vacuum breaker diverter 24 operates according to known principles to prevent an undesirable reverse fluid flow due to an underpressure condition that might develop after a flushing operation. As shown in FIG. 2A, the conventional vacuum breaker diverter 24 includes a first vertical tube 32 with a first opening 34. An upper end of a vertical pipe 22 can be placed in fluid communication with the first opening 34 of the vertical tube 32 while a lower end of the vertical pipe 22 can be placed in fluid communication with the flush valve 18. As further illustrated in FIGS. 2A and 2B, the conventional vacuum breaker diverter 24 also has a second vertical tube 36 in fluid communication with a second opening 38 and a third opening 40. A horizontal tube 26 includes the second opening 38 for supplying the flush rim 16 with water. In addition, the third opening 40 is configured for connecting to a flexible hose 30 for supplying water to the hand spray nozzle 28.

In use, an operator can press a foot pedal 20 to open a flush valve 18. Once the flush valve 18 is opened, water flows up through the vertical pipe 22, through the vacuum breaker diverter 24 and out the flush rim 16 into the toilet bowl 14. Additionally, while the foot pedal 20 is pressed, an operator can also use the hand spray nozzle 28 to assist in cleaning the toilet bowl 14. Using the hand spray nozzle 28 can help clean the toilet bowl 14 with less water when compared to cleaning operations only using the flush rim 16.

The conventional toilet 10 has proven effective to provide convenient cleaning of the toilet bowl with a reduced amount of water. However, the conventional vacuum breaker diverter 24 allows a significant portion of the water to be dispensed by the flush rim 16 while using the hand spray nozzle 28. Indeed, when using the hand spray nozzle 28, the conventional vacuum breaker diverter 24 is known to divide a water stream from a flush valve 18 such that slightly less than 41% of the water stream is dispensed by the hand spray nozzle 28 while the remaining portion of the water stream is dispensed by the flush rim 16. Therefore, more water may be required to perform the cleaning operation since a significant portion of the water continues to be dispensed by the flush rim 16 when using the hand spray nozzle 28. In addition, water may be dispensed at a lower velocity from the hand spray nozzle 28 if a substantial amount of water continues to be dispensed by the flush rim 16 when using the hand spray nozzle 28.

### BRIEF SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with an aspect of the present invention, a toilet apparatus adapted to be placed in fluid communication with a fluid source is provided comprising a bowl, a fluid dispenser adapted to dispense a fluid into the bowl, and a flush valve adapted to be placed in fluid communication with a fluid source. A spraying apparatus is further provided including a spray valve biased to a closed position, wherein the spraying apparatus is adapted to dispense a fluid upon opening of the spray valve. A vacuum breaker diverter is further provided in fluid communication with the flush valve, the fluid dispenser and the spraying apparatus. The vacuum breaker diverter is adapted to direct substantially all of a fluid stream from the flush valve to the fluid dispenser while the flush valve is open and the spray valve is closed. The vacuum breaker diverter is further adapted to direct greater than 41% of a fluid stream from the flush valve to the spraying apparatus while the flush valve is open and the spray valve is open.

In accordance with another aspect of the present invention, a toilet apparatus adapted to be placed in fluid communication with a fluid source is provided comprising a bowl, a fluid dispenser adapted to dispense a fluid into the bowl, and a flush valve adapted to be placed in fluid communication with a fluid source. A spraying apparatus is further provided including a spray valve biased to a closed position, wherein the spraying apparatus is adapted to dispense a fluid upon opening of the spray valve. A vacuum breaker diverter is further provided including a diverter chamber and a diverter device movable within the diverter chamber between a first position and a second position. The diverter device is adapted to move to the first position when the flush valve is open and the spray valve is closed. The diverter device is also adapted to move to the second position when the flush valve is open and the spray valve is open.

In accordance with yet another aspect of the present invention, a toilet apparatus adapted to be placed in fluid communication with a fluid source is provided comprising a bowl, a fluid dispenser adapted to dispense a fluid into the bowl, and a flush valve adapted to be placed in fluid communication with a fluid source. A spraying apparatus is further provided including a spray valve biased to a closed position, wherein the spraying apparatus is adapted to dispense a fluid upon opening of the spray valve. A vacuum breaker diverter is further provided including a diverter chamber and a diverter piston configured to reciprocate within the diverter chamber between a first position to direct substantially all of a fluid stream from the flush valve to the fluid dispenser and a second position to direct greater than 41% of a fluid stream from the flush valve to the spraying apparatus. The diverter piston is adapted to move to the first position when the flush valve is open and the spray valve is closed. The diverter piston is also adapted to move to the second position when the flush valve is open and the spray valve is open.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a partial exploded view of portions of a conventional toilet;

FIG. 2A is a front view of a conventional vacuum breaker of the toilet illustrated in FIG. 1;

FIG. 2B is a sectional view along line 2B-2B of the conventional vacuum breaker of FIG. 2A;

FIG. 3 is a partial exploded view of structures of an example toilet incorporating aspects of the present invention;

FIG. 4A is a front view of an example vacuum breaker diverter from FIG. 3;

FIG. 4B is a partial sectional view along line 4B-4B of the example vacuum breaker diverter of FIG. 4A;

FIG. 4C is a top view of the example vacuum breaker diverter of FIG. 4A; and

FIG. 4D is a sectional view of the example vacuum breaker along line 4D-4D of FIG. 4C.

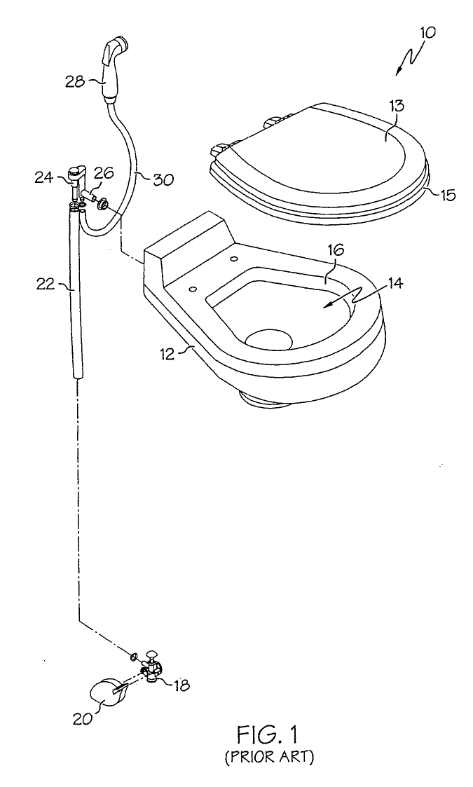

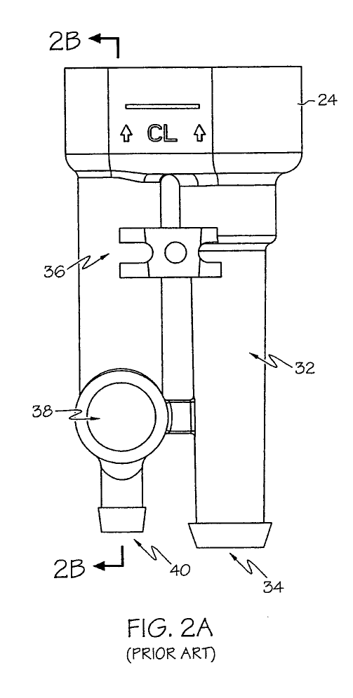

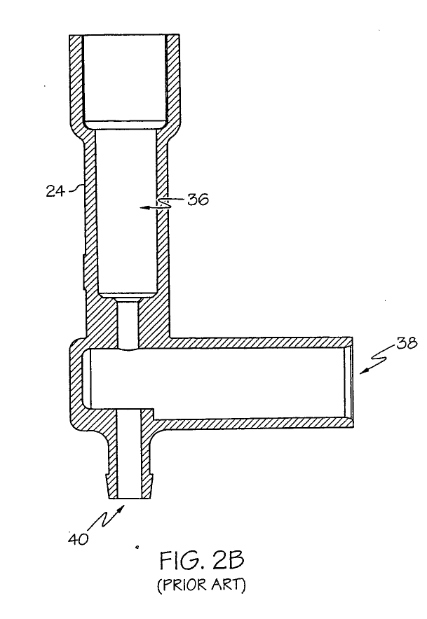

### DESCRIPTION OF EXAMPLE EMBODIMENTS

An example embodiment of a toilet apparatus that incorporates aspects of the present invention is shown in the drawings. It is to be appreciated that the shown example is not intended to be a limitation on the present invention. For example, one or more aspects of the present invention can be utilized in other embodiments and even other types of toilets.

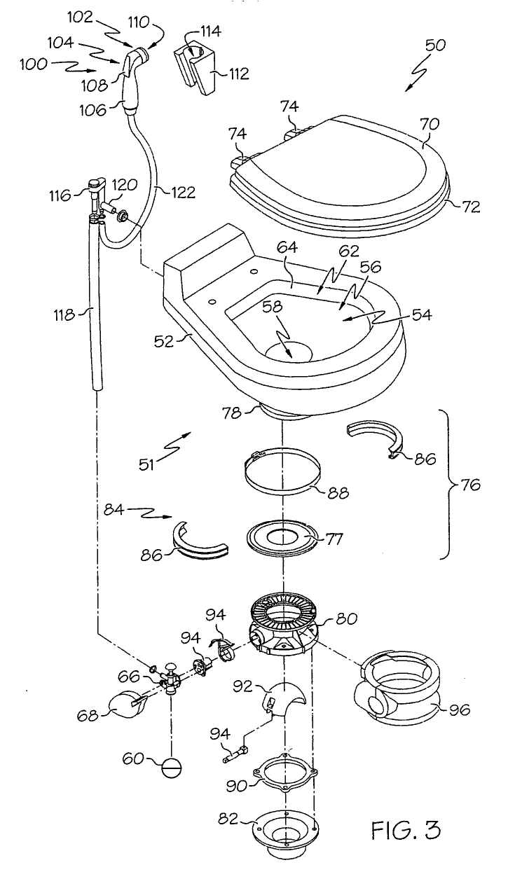

Toilet apparatus 50 in accordance with the present invention can include one or a plurality of structures shown in FIG. 3. The toilet apparatus can be incorporated as part of a toilet 51 shown in a simplified, schematic form. Various types of toilets can be configured for use in various vehicles, such as, for example, boats, ships, or recreational vehicles, and can also be adapted for use in a stationary structure, such as a home or other building. The toilet 51 can include a main body portion 52 having a toilet bowl 54 adapted to receive excrement (not shown), debris, and/or fluid from a user (not shown). The main body portion 52 can include various rigid materials, such as, for example, ceramic, porcelain, metal, and/or plastic. The toilet bowl 54 includes a first opening 56 disposed towards the top of the main body portion 52 and a second opening 58 disposed towards the bottom of the main body portion 52. The first opening 56 can be adapted to receive excrement (not shown), debris and or fluids from a user (not shown) and the second opening 58 can be adapted to permit the excrement, debris (not shown) and/or a fluid to exit the bowl 54. In the shown example, the bowl 54 has a generally concave configuration, adapted to direct the excrement, debris, and/or fluids from the first opening 56 towards the second opening 58.

The toilet 51 can use a fluid (not shown) to clean the toilet bowl 54 during a flushing cycle. In the shown example, the fluid comprises water but, in addition or alternatively, may include various fluids capable of flushing the excrement and/or other debris (not shown) from the bowl 54. For instance, fluid may comprise a single fluid type, a mixture of fluid types, or a mixture of solids and fluids. For example, the fluid 54 may consist of water, a detergent, holding tank additive and/or the like.

The fluid can be supplied to the toilet 51 by a fluid source 60, shown schematically in FIG. 3. The fluid source 60 can be pressurized such that the fluid is caused to flow towards the toilet 51. The fluid source 60 can be pressurized by a remote source, such as by a suitable pressure system located on a vehicle or by suitable structure connected to a municipal water supply. The fluid source 60 can also be located in a holding tank capable of being pressurized to provide a pressurized fluid source. In the shown example, the fluid source 60 comprises a pressurized water source, though, as discussed above, the fluid can be a single fluid type, a mixture of fluid types, or a mixture of solids and fluids. Further, where the fluid comprises a mixture of fluids and/or solids, the separate components of the mixture need not all originate from the fluid source 60, but instead may be added and/or mixed before entering the toilet 51. Accordingly, the toilet 51 can include appropriate structure (not shown) adapted to mix the various components to achieve a desired fluid mixture.

The main body portion 52 can further include a fluid dispenser 62 for dispensing the fluid for cleaning the toilet bowl 54. In the shown example, the fluid dispenser 62 can be incorporated in a toilet rim 64 surrounding the toilet bowl 54. In addition or alternatively, the fluid dispenser may be incorporated in other surfaces of the toilet bowl 54 and may even be located near or within the second opening 58. The fluid dispenser can also comprise a separate device or may be incorporated as part of the toilet and can be adapted to dispense fluid in a wide range of manners. For example, the fluid dispenser 62 can include a hole (not shown), or a plurality of holes, in the toilet rim 64 to allow the fluid to pass from the toilet rim 64 and into the toilet bowl 54. In addition or alternatively, the fluid dispenser 62 can comprise a nozzle having a spout (not shown), or a plurality of nozzles having a plurality of spouts (not shown). It is to be appreciated that the fluid dispenser can also comprise a wide range of further structures and configurations designed to dispense a liquid into the toilet bowl 54.

In the illustrated embodiment, fluid from the fluid source 60 can be released into the toilet bowl 54 by the opening of a flush valve 66. The flush valve 66 can be placed in fluid communication with the fluid source 60 and can be normally biased to a closed position. The flush valve 66 can be opened in various manners. For example, as shown, a foot pedal 68 can be operably connected to the flush valve 66 to allow hands-free opening of the flush valve. In addition or alternatively, the flush valve 66 can be provided with a lever, a push button, a chain pull, or other structure.

The toilet 51 can further include any number of elements to compliment functionality and installation of the toilet. For example, the toilet 51 can include a lid 70 adapted to cover the toilet bowl 54. The toilet 51 can also include a seat 72 (shown in part) adapted to permit a user to sit upon the toilet 51. The lid 70 and/or seat 72, if provided, can be pivotally attached to the toilet 51 by one or more hinges 74.

The toilet 51 can also include mounting structure 76 adapted to mount the toilet 51 to a drain (not shown). The mounting structure 76 can include a seal 77 adapted to provide a sealed connection between a base portion 78 of the toilet 51 and a discharge valve housing 80. The base portion 78 of the toilet 51 can be in fluid communication with the second opening 58 of the toilet bowl 54, and the discharge valve housing 80 can be in fluid communication with a flange 82. The flange 82 can be adapted to attach to the drain (not shown), to thereby provide a discharge pathway for the excrement, debris and/or fluid out of the toilet bowl 54. The base portion 78 of the toilet 51 can be secured to the discharge valve housing 80 by way of a clamping member 84. The clamping member 84 can include a clamp element 86 and a retainer member 88. As shown, two semi-circular clamp elements 86 can be adapted to engage corresponding structure of the base portion 78 and the discharge valve housing 80. Next, the retainer member 88 can be adapted to fit around the clamp elements 86 and tightened to maintain a sealed connection between the base portion 78 and the discharge valve housing 80. The retainer member can comprise various retainers, such as, for example, a hose clamp. The discharge valve housing 80 can be secured to the flange 82, for example, with fasteners. A gasket 90 can also be disposed between the discharge valve housing 80 and the flange 82 to provide a sealed connection therebetween.

The discharge valve housing 80 can include a discharge valve 92. The discharge valve 92 can be adapted to selectively close the communication between the base portion 78 of the toilet 51 and the drain (not shown). Thus, when the discharge valve 92 is closed, any contents of the toilet bowl 54 (e.g., excrement, debris, and/or fluid) can remain therein, and when the discharge valve 92 is opened, the contents of the toilet bowl 54 can be dumped into the drain (not shown). The toilet 51 can further include linkage structure 94 adapted to open the discharge valve 92 automatically upon an opening of the flush valve 66. Upon opening the discharge valve 92, any excrement, debris, and/or fluid contained within the toilet bowl 54 can be directed towards the drain (not shown). In addition or alternatively, the linkage structure 94 can be adapted to permit a user to manually open the discharge valve 92. Further still, the toilet 51 can include a discharge valve cover 96 adapted to enclose the discharge valve housing 80 and/or the linkage structure 94.

The toilet apparatus 50 can further include a spraying apparatus 100 having a spray valve 102 biased to a closed position. The spraying apparatus 100 can be adapted to dispense the fluid upon opening of the spray valve 102. As shown, the spraying apparatus 100 comprises a hand sprayer 104 that can include a grip portion 106 adapted to permit a user to easily manipulate the hand sprayer 104 during use. Further, the hand sprayer 104 can be provided with a trigger 108 to open the spray valve 102. It is to be appreciated that the spraying apparatus 100 is not intended to be limited to a hand sprayer, and can comprise various other types of spraying apparatus having various geometries.

Additionally, the spraying apparatus 100 can include a nozzle 110. As shown, the nozzle 110 is disposed at one end of the hand sprayer 104 and can be adapted to discharge a fluid away from the user. The nozzle 110 can be designed to produce various spray patterns such as a focused jet spray to perform high-pressure cleaning operations. Alternatively, the nozzle 110 can be designed to restrict liquid flow and/or provide a dispersed pattern to perform low-pressure cleaning operations. The spraying apparatus 100 can also include a plurality of nozzles 110 forming various types of spray patterns. For example, a plurality of nozzles 110 including a plurality of jets can form a plurality of jet sprays configured to perform various high-pressure and/or low-pressure cleaning operations.

The spraying apparatus 100 can further be provided with a storage unit 112. As shown, the storage unit 112 can include an aperture 114 adapted to receive a portion of the spraying apparatus. In the shown example, the aperture 114 can be adapted to receive the grip portion 106. In addition or alternatively, the storage unit 112 can be adapted to engage various portions of the spraying apparatus 100 to store it while it is not in use. Further still, the storage unit 112 can be adapted to mount to a wall (as shown), the toilet 51, or various other structures.

The toilet apparatus 50 includes a vacuum breaker diverter 116 in fluid communication with at least the flush valve 66, the fluid dispenser 62, and the spraying apparatus 100. In the shown example of FIG. 3, the vacuum breaker diverter 116 can be in fluid communication with the flush valve 66, the fluid dispenser 62, and the spraying apparatus 100 through a first conduit 118, a second conduit 120, and a third conduit 122, respectively. As shown, the conduits 118, 120, 122 can include flexible and/or non-flexible materials. For example, the third conduit 122 can include a flexible material to permit a user to easily manipulate the hand sprayer 104. It is to be appreciated that the vacuum breaker diverter 116 can receive fluid from additional sources, and/or can supply fluid to additional elements. As shown, the vacuum breaker diverter 116 is located downstream of the flush valve 66 although other configurations may be provided in further examples.

The vacuum breaker diverter 116 can be adapted to direct substantially all of a fluid stream from the flush valve 66 to the fluid dispenser 62 while the flush valve 66 is open and the spray valve 102 is closed. Additionally, the vacuum breaker diverter 116 can direct at least a substantial portion of the fluid stream from the flush valve 66 to the spraying apparatus 100 when the flush valve 66 is open and the spray valve 102 is open. For example, although not required in each embodiment of the invention, the vacuum breaker diverter 116 can be adapted to direct greater than 41% of a fluid stream from the flush valve 66 to the spraying apparatus 100 while the flush valve 66 is open and the spray valve 102 is open. In another example, the vacuum breaker diverter 116 can be adapted to direct at least about 45% of a fluid stream from the flush valve 66 to the spraying apparatus 100 while the flush valve 66 is open and the spray valve 102 is open. In a further example, the vacuum breaker diverter 116 can be adapted to direct at least about 55% of a fluid stream from the flush valve 66 to the spraying apparatus 100 while the flush valve 66 is open and the spray valve 102 is open. In yet another example, the vacuum breaker diverter 116 can be adapted to direct at least about 65% of a fluid stream from the flush valve 66 to the spraying apparatus 100 while the flush valve 66 is open and the spray valve 102 is open. In still further examples, the vacuum breaker diverter 116 can be adapted to direct at least about 67% of a fluid stream from the flush valve 66 to the spraying apparatus 100 while the flush valve 66 is open and the spray valve 102 is open.

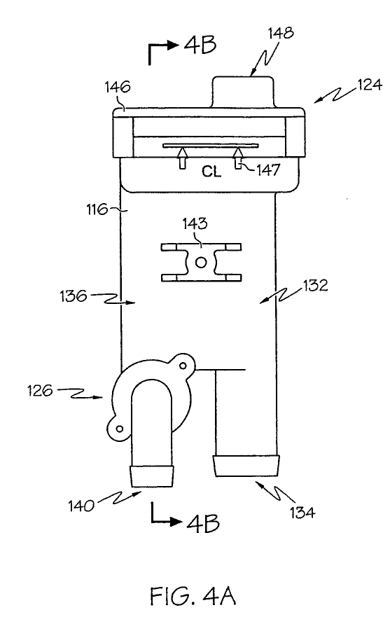

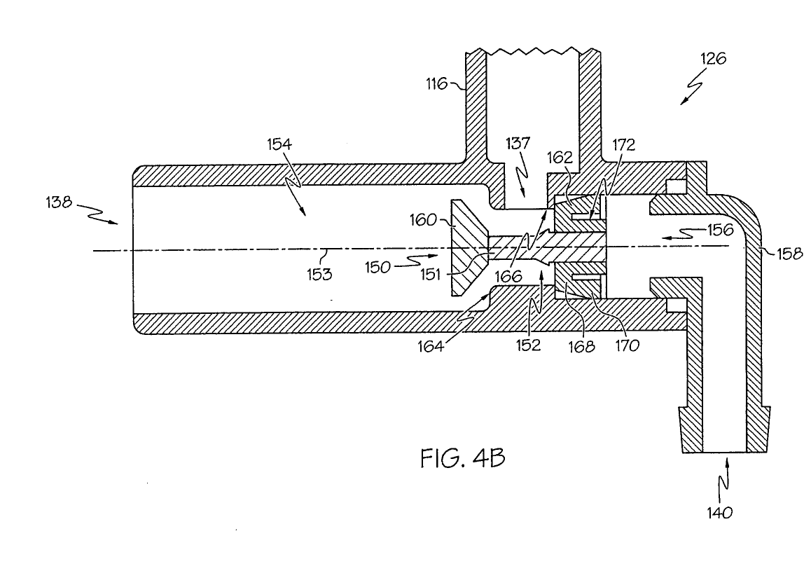

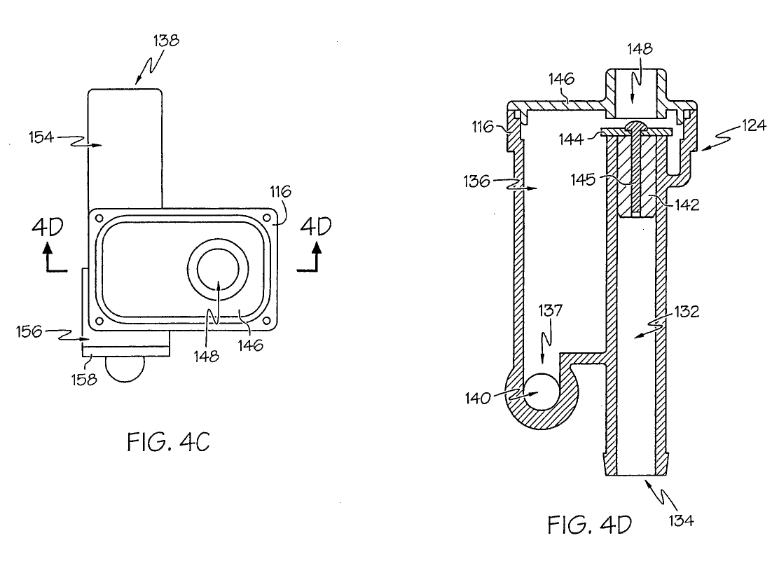

Turning to the example shown in FIG. 4A, an exemplary vacuum breaker diverter 116 will be described in further detail. The vacuum breaker diverter 116 can include a vacuum breaker portion 124 that can be adapted to prevent an underpressure condition in the system after a flush cycle. Further, the vacuum breaker diverter 116 can include a diverter portion 126 (see FIG. 4B) that can be adapted to divert substantially all of a fluid stream to the fluid dispenser 62, or at least a substantial portion of a fluid stream to the spraying apparatus 100 as discussed above.

As shown in FIGS. 4A-4D, the vacuum breaker portion 124 can have a first chamber 132 having a first opening 134 adapted to receive water from the water source 60. For example, as shown in FIG. 3, the first opening 134 can be in fluid communication with the flush valve 66 through the first conduit 118. Returning to FIGS. 4A-4D, the vacuum breaker portion 124 can also have a second chamber 136 that can be in fluid communication with a second opening 138 and a third opening 140 through a chamber opening 137. As shown in FIG. 3, the second opening 138 can be in fluid communication with the fluid dispenser 62 through the second conduit 120, and the third opening 140 can be in fluid communication with the spraying apparatus 100 through the third conduit 122.

The vacuum breaker portion 124 can further comprise a check valve 142 in fluid communication with the flush valve 66. The check valve 142 can be adapted to inhibit backflow from either the spraying apparatus 100 or the fluid dispenser 62 after a flushing operation. For example, the check valve 142 can comprise a poppet valve or various other valves adapted to inhibit backflow. As shown, the check valve 142 can include a seal 144 adapted to seal the first chamber 132 from the second chamber 136. Thus, for example, any backflow of fluid from the second chamber 136 cannot enter the first chamber 132 after a flushing operation or otherwise. The seal 144 can be fixedly or removably attached to the check valve 142 in various manners, such as through a pin 145 or other fastener.

The vacuum breaker portion can comprise various structures configured to prevent an underpressure condition within the second chamber 136. For example, the illustrated vacuum breaker portion comprises a cover plate 146 adapted to provide a cover for the second chamber 136. As shown, the cover plate 146 can include an atmospheric vent 148 adapted to prevent an underpressure condition (e.g., a vacuum) from developing within the second chamber 136. It is to be appreciated that the cover plate 146 as shown is not intended to provide any limitations upon the present invention, and that any cover plate 146 having various (or multiple) atmospheric vent(s) 148 can be used.

The vacuum breaker diverter 116 can also include other structure. For example, it can include a mounting bracket 143 adapted to mount the vacuum breaker diverter 116 to structures, such as, for example, the toilet 51 or the wall of a building or vehicle (not shown). The vacuum breaker diverter 116 can be removably or permanently mounted in various manners. Further still, the vacuum breaker diverter 116 can include an indicator 147 adapted to indicate the centerline of the seal 144. For example, an indicator 147 can be used to ensure that the vacuum breaker diverter 116 is substantially level when it is mounted to the toilet 51 or other structure (not shown) to thereby achieve good performance of the vacuum breaker portion 126. Further still, the seal 144 can include various structure adapted to seal against the first chamber 134 and/or the atmospheric vent 148, such as, for example, a lip or a groove (not shown).

In operation, for example, fluid can enter the first chamber 132 from the first opening 134 when the flush valve 66 is actuated. The inflow of the pressurized fluid can cause the check valve 142 to move in an upward direction until the seal 144 sealingly engages the atmospheric vent 148. The fluid can then flow from the first chamber 132 and into the second chamber 136, where the diverter portion 126 can divert the fluid stream to the fluid dispenser 62 or the spraying apparatus 100, as described more fully herein. Once the flush valve 66 is closed and the fluid ceases to flow within the first chamber 132, the check valve 142 can return to its initial position and sealingly engage the first chamber 132. As shown, the check valve 142 can return to its initial position by the force of gravity, although the check valve 142 can be resiliently biased towards the first chamber 132 with a spring or other biasing member. Thus, as the remainder of the fluid in the second chamber 136 flows to either the fluid dispenser 62 or the spraying apparatus 100, atmospheric air can enter through the atmospheric vent 148 to prevent an underpressure condition within the second chamber 136.

Turning now to FIG. 4B, the diverter portion 126 can be adapted to divert at least a substantial portion of the fluid stream from the flush valve 66 to the spraying apparatus 100 when the flush valve 66 and the spray valve 102 are opened. For example, although not required in all embodiments, the diverter portion 126 can be adapted to divert greater than 41%, at least about 45%, at least about 55%, at least about 65%, and/or at least about 67% of a fluid stream to the spraying apparatus 100 when the flush valve 66 and the spray valve 102 are opened. In one example, the diverter portion 126 can comprise a diverter chamber 152 and at least one diverter device 150 movable within the diverter chamber 152. The diverter device 150 can be capable of selectively directing the fluid to at least the fluid dispenser 62 or the spraying apparatus 100. For example, the diverter device 150 can be configured to move within the diverter chamber 152 between a first position (shown in FIG. 4B) when the flush valve 66 is open and the spray valve 102 is closed. The diverter device 150 can also shift to the right (from the position shown in FIG. 4B) to a second position when the flush valve 66 is open and the spray valve 102 is open.

The diverter chamber 152 can be in fluid communication with the second chamber 136 through the chamber opening 137. The diverter chamber 152 can also be in fluid communication with the second opening 138 through a flush chamber 154, and the third opening 140 through a spraying chamber 156. For example, the third opening 140 can be part of a spraying tube 158 sealingly attached to the spraying chamber 156, or alternatively it can be formed with the spraying chamber 156. As shown in FIG. 3, the spray valve 102 of the spraying apparatus 100 can be in fluid communication with the spraying tube 158 through the third conduit 122.

In one example, the diverter device 150 can comprise a diverter piston 151. In addition or alternatively, the diverter device 150 can comprise other structure, such as may be found in, for example, a globe valve, a ball valve, and/or a butterfly valve. The diverter piston 151, if provided, can include a first diverter seal 160 and a second seal 162. The diverter seals 160, 162 can be fixedly or removably attached to the diverter piston 151 in various manners. The diverter seals 160, 162 can include various materials adapted to provide a seal between the diverter chamber 152 and the flush and/or spraying chambers 154, 156. For example, the diverter seals 160, 162 can include plastic, rubber, and or metal. It is also to be appreciated that either, or both, of the diverter seals 160, 162 can be formed with the diverter piston 150. In addition or alternatively, the diverter seals 160, 162 can include other structure adapted to provide a seal between the diverter chamber 152 and the flush and/or spraying chambers 154, 156. For example, the diverter seals 160, 162 can include o-rings, or the like.

The first and second diverter seals 160, 162 of the diverter piston 151 can be adapted to seal against first and second surfaces, respectively, of the vacuum breaker diverter 116. For example, as shown in FIG. 4B, the diverter chamber 152 can have a smaller area than the flush chamber 154 to thereby create a first seat 164 for the first diverter seal 160. Similarly, the diverter chamber 152 can have a smaller area than the spraying chamber 156 to create a second seat 166 for the second diverter seal 162. Thus, the first and second diverter seals 160, 162 can be adapted to alternatively sealingly engage the first and second seats 164, 166, respectively, to provide a seal between the diverter chamber 152 and the flush chamber 154 and, alternatively, between the diverter chamber 152 and the spraying chamber 156.

As shown in FIGS. 4A-4D, the first and second seats 164, 166 can have a circular geometry, and the diverter seals 160, 162 can have a corresponding frusto-conical geometry adapted to sealingly engage the seats 164, 166. That is, a portion of the diverter seals 160, 162 can abut the seats 164, 166 to provide a fluid seal between the diverter chamber 152 and the flush chamber 154 and/or the spraying chamber 156.

In addition, the diverter seals 160, 162 can have a rigid or flexible geometry. For example, the first diverter seal 160, as shown, can have a substantially solid geometry that can provide a rigid seal. The diverter seal 160 is designed to seal against the seat 164 when the diverter piston 151 is in the second position (shifted to the right). In another example, the second diverter seal 162, as shown, can include both a base portion 168 and a flexible portion 170. Thus, the base portion 168 can have a substantially solid geometry adapted to sealingly engage the second seat 166 in the illustrated first position. The flexible portion 170 can have a solid configuration, or, as shown, can include a groove 172 adapted to permit portions of the second diverter seal 162 to flex and bias against the inner surface of the spraying chamber 156 at each position of the diverter piston within the diverter chamber. Further still, the diverter seals 160, 162 can include portions that are larger than the first and second seats 164, 166 so as to prevent backflow into the diverter chamber 152 from either of the flushing chamber 154 and/or the spraying chamber 156.

The diverter piston 151 can be adapted to selectively move either the first or second diverter seals 160, 162 into sealing engagement with the first or second seats 164, 166. In the shown example of FIG. 4B, the base portion 168 of the second diverter seal 162 engages the second seat 166 when the diverter piston is moved to the first position. Alternatively, diverter piston 151 may be shifted to the right to the second position wherein the first diverter seal 160 engages the first seat 164.

The diverter device can be configured to move within the diverter chamber between a first position when the flush valve is open and the spray valve is closed and a second position when the flush valve is open and the spray valve is open. The diverter device can move in a wide variety of ways from the first to second position. For example, the diverter device can reciprocate, translate, move along a linear or nonlinear path, pivot, rotate and/or otherwise move within the diverter chamber. In the illustrated example, the diverter piston 151 is configured to reciprocate, translate, and move along a linear path 153 within the diverter chamber 152 from a first position (shown in FIG. 4B) when the flush valve 66 is open and the spray valve 102 is closed and a second position (shifted to the right from FIG. 4B), when the flush valve 66 is open and the spray valve 102 is open.

In operation, once the flush valve 66 is opened, pressurized fluid from the fluid source 60 (e.g., water or fluid mixture) can flow through the first conduit 118 to the vacuum breaker diverter 116. The fluid can flow through the vacuum breaker portion 124 as discussed above to prevent an underpressure condition in the system after a flush cycle. The fluid can then flow through the diverter portion 126 by passing through the chamber opening 137 of the second chamber 136 and into the diverter chamber 152.

When the spray valve 102 is closed, the diverter portion 126 is adapted to direct substantially all of the fluid to the fluid dispenser 62. Thus, for example, the force supplied by the pressurized fluid can bias the diverter piston 151 to the first position shown in FIG. 4B wherein the second seal 170 seals against the second seat 166. The fluid stream can then flow around the first seal 160 and through the second conduit 120 to the main body portion 52 of the toilet 51. The fluid dispenser 62 then dispenses the fluid stream into the toilet bowl 54. In addition or alternatively, a spring or other resilient member can resiliently bias the diverter piston 151 to one of the first or second positions. Furthermore, as discussed above, the flush valve 66 can also actuate the discharge valve 92 to an open position to provide a discharge pathway for the fluid, excrement, and/or debris.

When the spray valve 102 is open and the flush valve 66 is open, the diverter portion 126 can be adapted to direct at least a substantial portion of the fluid to the spraying apparatus 100 through the third conduit 122. Thus, for example, a force differential acting the diverter device 150 can shift the diverter piston 151 to the right from the first position illustrated in FIG. 4B to the second position (not shown) wherein the first diverter seal 160 seals against the first seat 164. Once the first diverter seal 160 seals against the first seat 164, at least a substantial portion of the fluid stream is directed to the spraying apparatus 100 and at least a portion of fluid stream is inhibited from passing to the fluid dispenser 62.

As the fluid flows around the second diverter seal 162, the force from the pressurized fluid can compress the flexible portion 170 of the second diverter seal 162 to permit the fluid to flow around the second diverter seal 162 and into the spraying tube 158. The fluid can then flow out of the third opening 140 and through the third conduit 122, out of the nozzle 110 of the spraying apparatus 100. When the spray valve 102 is subsequently closed, the flexible portion 170 of the second diverter seal 162 can be resiliently biased outwards to thereby prevent any backflow from fluid remaining in the third conduit 122 and/or the spraying tube 158.

It is also to be appreciated that the flush valve 66 can be adapted to provide fluid from the fluid source 60 to the vacuum breaker diverter 116 so long as the flush valve 66 is open. For example, a user can keep the flush valve 66 opened for an extended period of time if it is desired to use the spraying apparatus 100 in a continuous manner. Further, when a user is using the spraying apparatus 100 and subsequently closes the spray valve 102, the force supplied by the pressurized fluid can then bias the diverter piston 151 and the first diverter seal 160 back towards the first position (shown in FIG. 4B) such that substantially all of the fluid flow is discharged out of the fluid dispenser 62.

Thus, if it is desired, a user can use the spraying apparatus 100 to clean the toilet bowl 54. It is to be appreciated that the user can also use the spraying apparatus 100 to clean other items. As features of the present invention permit at least a substantial portion of the pressurized fluid to be dispensed by the spraying apparatus 100, it may be possible to effectively clean the toilet bowl 54 with less water as opposed to using solely the fluid dispenser 62.

The invention has been described with reference to the preferred embodiments. Obviously, modifications and alterations will occur to others upon a reading and understanding of this specification. It is intended to include all such modifications and alterations insofar as they come within the scope of the appended claims or the equivalents thereof.

What is claimed is:

1. A toilet apparatus adapted to be placed in fluid communication with a fluid source, the toilet apparatus comprising:
a bowl;
a fluid dispenser adapted to dispense a fluid into the bowl;
a flush valve adapted to be placed in fluid communication with a fluid source;
a spraying apparatus including a spray valve biased to a closed position, wherein the spraying apparatus is adapted to dispense a fluid upon opening of the spray valve; and
a vacuum breaker diverter in fluid communication with the flush valve, the fluid dispenser and the spraying apparatus,
wherein the vacuum breaker diverter is adapted to direct substantially all of a fluid stream from the flush valve to the fluid dispenser while the flush valve is open and the spray valve is closed, and wherein the vacuum breaker diverter is further adapted to direct greater than 41% of a fluid stream from the flush valve to the spraying apparatus while the flush valve is open and the spray valve is open.

2. The toilet apparatus of claim 1, wherein the vacuum breaker diverter is adapted to direct at least about 45% of a fluid stream from the flush valve to the spraying apparatus while the flush valve is open and the spray valve is open.

3. The toilet apparatus of claim 1, wherein the vacuum breaker diverter is adapted to direct at least about 55% of a fluid stream from the flush valve to the spraying apparatus while the flush valve is open and the spray valve is open.

4. The toilet apparatus of claim 1, wherein the vacuum breaker diverter is adapted to direct at least about 65% of a fluid stream from the flush valve to the spraying apparatus while the flush valve is open and the spray valve is open.

5. The toilet apparatus of claim 1, wherein the vacuum breaker diverter includes a diverter chamber and a diverter device movable within the diverter chamber.

6. The toilet apparatus of claim 5, wherein the diverter device is configured to move within the diverter chamber between a first position when the flush valve is open and the spray valve is closed and a second position when the flush valve is open and the spray valve is open.

7. The toilet apparatus of claim 5, wherein the diverter device is configured to reciprocate within the diverter chamber.

8. The toilet apparatus of claim 5, wherein the diverter device is configured to translate within the diverter chamber.

9. The toilet apparatus of claim 5, wherein the diverter device is configured to move along a linear path within the diverter chamber.

10. The toilet apparatus of claim 1, further comprising a foot pedal operably connected to the flush valve.

11. A toilet apparatus adapted to be placed in fluid communication with a fluid source, the toilet apparatus comprising:
a bowl;
a fluid dispenser adapted to dispense a fluid into the bowl;
a flush valve adapted to be placed in fluid communication with a fluid source;
a spraying apparatus including a spray valve biased to a closed position, wherein the spraying apparatus is adapted to dispense a fluid upon opening of the spray valve; and
a vacuum breaker diverter including a diverter chamber and a diverter device movable within the diverter chamber between a first position and a second position, wherein the diverter device is adapted to move to the first position when the flush valve is open and the spray valve is closed, and wherein the diverter device is adapted to move to the second position when the flush valve is open and the spray valve is open.

12. The toilet apparatus of claim 11, wherein the diverter device is adapted to move from the first position to the second position in response to a fluid force differential acting on the diverter device.

13. The toilet apparatus of claim 11, wherein the diverter device comprises a diverter piston.

14. The toilet apparatus of claim 11, wherein the diverter device is configured to be oriented in the second position to cause greater than 41% of a fluid stream from the flush valve to be dispensed by the spraying apparatus while the flush valve is open and the spray valve is open.

15. The toilet apparatus of claim 11, wherein the diverter device is configured to be oriented in the second position to cause at least about 45% of a fluid stream from the flush valve to be dispensed by the spraying apparatus while the flush valve is open and the spray valve is open.

16. The toilet apparatus of claim 11, wherein the diverter device is configured to be oriented in the second position to cause at least about 55% of a fluid stream from the flush valve to be dispensed by the spraying apparatus while the flush valve is open and the spray valve is open.

17. The toilet apparatus of claim 11, wherein the diverter device is configured to be oriented in the second position to cause at least about 65% of a fluid stream from the flush valve to be dispensed by the spraying apparatus while the flush valve is open and the spray valve is open.

18. A toilet apparatus adapted to be placed in fluid communication with a fluid source, the toilet apparatus comprising:
a bowl;
a fluid dispenser adapted to dispense a fluid into the bowl;
a flush valve adapted to be placed in fluid communication with a fluid source;
a spraying apparatus including a spray valve biased to a closed position, wherein the spraying apparatus is adapted to dispense a fluid upon opening of the spray valve; and
a vacuum breaker diverter including a diverter chamber and a diverter piston configured to reciprocate within the diverter chamber between a first position to direct substantially all of a fluid stream from the flush valve to the fluid dispenser and a second position to direct greater than 41% of a fluid stream from the flush valve to the spraying apparatus, wherein the diverter piston is adapted to move to the first position when the flush valve is open and the spray valve is closed, and wherein the diverter piston is adapted to move to the second position when the flush valve is open and the spray valve is open.

19. The toilet apparatus of claim 18, wherein the diverter piston is configured to be oriented in the second position to cause at least about 45% of a fluid stream from the flush valve to be dispensed by the spraying apparatus while the flush valve is open and the spray valve is open.

20. The toilet apparatus of claim 18, wherein the diverter piston is configured to be oriented in the second position to cause at least about 55% of a fluid stream from the flush valve to be dispensed by the spraying apparatus while the flush valve is open and the spray valve is open.

21. The toilet apparatus of claim 18, wherein the diverter piston is configured to be oriented in the second position to cause at least about 65% of a fluid stream from the flush valve to be dispensed by the spraying apparatus while the flush valve is open and the spray valve is open.

22. The toilet apparatus of claim 18, wherein the diverter piston further comprises a first diverter seal adapted to seal against a first surface of the vacuum breaker diverter and a second diverter seal adapted to seal against a second surface of the vacuum breaker diverter.

23. The toilet apparatus of claim 22, wherein at least one of the first and second diverter seals comprises a flexible portion adapted to substantially permit a fluid to flow in only one direction.

24. The toilet apparatus of claim 22, wherein the first diverter seal is only configured to seal against the first surface when the diverter piston is in the second position within the diverter chamber and wherein the second diverter seal is biased to seal against the second surface at each position of the diverter piston within the diverter chamber.
